(19) United States
(12) Patent Application Publication
(10) Pub. No.: US 2011/0147323 A1
(43) Pub. Date: Jun. 23, 2011

(54) System and Method for Displaying and Dispensing Merchandise Articles of Selected Dimensions

(76) Inventors: Anthony V. Sainato, Pittsburgh, PA (US); Andrew B. Sholl, Cranbury, NJ (US); Lee A. Wintermantel, Moon Township, PA (US)

(21) Appl. No.: 12/642,990

(22) Filed: Dec. 21, 2009

(51) Int. Cl. A47F 7/00; G09F 3/20

(52) U.S. Cl. 211/59.2; 40/642.02

(57) ABSTRACT

A system of modular components enables the selection and assembly of components of the system to accommodate a compact display, effective dispensing by gravity-feed, and convenient restocking of merchandise articles of different dimensions at a compact matrix of dispensing locations placed at a point-of-purchase. Selected chutes are assembled with counterpart selected left and right sidewalls for carrying merchandise articles of selected dimensions, with the lateral spacing between the sidewalls being determined by the lateral width of the selected chutes. The chutes are engaged with the sidewalls for sliding movement between a retracted position, wherein a forward end of a selected chute is placed at a corresponding dispensing location for presenting the carried merchandise articles for dispensing at the point-of-purchase, and an advanced position, wherein the selected chute is exposed adjacent a rearward end of the chute to permit access to the selected chute adjacent the rearward end from a forward position adjacent a corresponding dispensing location of the matrix of dispensing locations for enabling restocking of the selected chute directly, adjacent the rearward end of the selected chute, from the forward position.

The present invention relates generally to point-of-purchase display and dispensing of merchandise articles and pertains, more specifically, to a system of modular components and a method for assembling selected components of the system to accommodate the display and dispensing, by gravity-feed, of merchandise articles of different dimensions presented at a relatively compact matrix of dispensing locations placed at a point-of-purchase and constructed for convenient restocking.

An ever-increasing variety of merchandise articles offered to consumers at points-of-purchase in retail settings presents new challenges to retail merchants seeking to offer to consumers a wider choice of such merchandise articles while conserving the space needed to establish the effective display and dispensing of the merchandise articles, and especially where the merchandise articles require a controlled environment, such as refrigeration. For example, dairy products, such as yogurt, are offered to customers in a variety of containers of different dimensions, all of which containers must be refrigerated and presented at a convenient point-of-purchase, advantageously placed in a compact array of dispensing locations in order to conserve refrigerated space, and thereby realize a concomitant conservation of energy, while still presenting the consumer with an attractive and convenient dispensing display. At the same time, it is important that the merchant be able to maintain, with ease, a well-stocked, inviting display of the various-sized merchandise articles.

The present invention provides a system and method which address the need to accommodate the display and dispensing of the variety of merchandise articles, in different sizes, as described above, while facilitating convenient restocking. As such, the present invention attains several objects and advantages, some of which are summarized as follows: Provides a system of modular components made available for enabling the assembly of selected components to accommodate the display and dispensing, by convenient gravity-feed, of merchandise articles of different dimensions at a relatively compact matrix of dispensing locations placed at a point-of-purchase; facilitates restocking of a gravity-feed merchandise article display and dispensing apparatus, conveniently from a forward position adjacent the dispensing location of the display and dispensing apparatus; enables a conservation of space at a point-of-purchase while providing for the display and dispensing at the point-of-purchase, by gravity-feed, of conveniently restocked merchandise articles selected from a plurality of merchandise articles of different dimensions, with a concomitant conservation of energy where the merchandise articles require a controlled environment, such as a refrigerated space; provides a very high degree of versatility in the ability to accommodate a maximum number of merchandise articles of different dimensions in a conveniently restocked gravity-feed display and dispensing apparatus of minimum dimensions; facilitates the establishment and maintenance of an attractive, well-stocked display and dispensing apparatus at a point-of-purchase for merchandise articles of various dimensions, particularly where the merchandise articles must be maintained in a controlled environment; provides a system of modular components of relatively simple construction and economical manufacture for selection to assemble a conveniently restocked gravity-feed display and dispensing apparatus that presents a maximum number of merchandise articles of different dimensions within a relatively compact matrix of dispensing locations placed at a point-of-purchase; enables simple, on-site assembly of an effective and conveniently restocked gravity-feed display and dispensing apparatus for accommodating merchandise articles of different dimensions with increased ease and economy, without the need for special tools or special skills, especially in locations requiring a controlled environment for the display and dispensing of the merchandise articles; provides for the reliable and economical display and dispensing of conveniently restocked merchandise articles of selected dimensions, over an extended service life.

The above objects and advantages, as well as further objects and advantages, are attained by the present invention which may be described briefly as a system of modular components for assembly of selected components of the system to accommodate a compact display, effective dispensing by gravity-feed, and convenient restocking of merchandise articles selected from merchandise articles of different dimensions, including merchandise articles having different lateral widths and different altitudinal heights, at a matrix of dispensing locations placed at a point-of-purchase, the system of modular components comprising: a plurality of left and right sidewalls, each sidewall having a forward end, a rearward end, a lower edge, an upper edge, and an inner face extending longitudinally between the forward and rearward ends and altitudinally between the lower and upper edges; a plurality of chutes, each chute extending along a longitudinal direction between a forward end and a rearward end, each chute having a left side, a right side and a lateral width between the left side and the right side, the lateral width of at least some of the chutes of the plurality of chutes being different from others of the plurality of chutes, the different lateral widths of the chutes corresponding to the different lateral widths of the merchandise articles; and retainers on the inner face of each sidewall, the retainers extending along respective longitudinal directions between respective forward and rearward ends of the left sidewall and the right sidewall, the retainers being dimensioned and configured to establish a track along each sidewall for receiving a selected chute in engagement with the selected left and right sidewalls, with the tracks providing a corresponding path of travel for merchandise articles carried by the selected chute along the corresponding longitudinal direction toward a corresponding dispensing location; the selected chute being received within the tracks in sliding engagement with the selected left and right sidewalls such that upon engagement of the selected chute with retainers of the selected left and right sidewalls, the selected left sidewall and the selected right sidewall will be spaced apart by the lateral width of the selected chute, and the selected chute will be coupled with the selected left and right sidewalls for sliding movement between a retracted position, wherein the rearward end of the selected chute is juxtaposed with the rearward ends of the selected left and right sidewalls, while the forward end of the selected chute is placed at a corresponding dispensing location juxtaposed with the forward ends of the selected left and right sidewalls so as to enable the display and dispensing of merchandise articles from the forward end of the selected chute, at the corresponding dispensing location, and an advanced position, wherein the rearward end of the selected chute is juxtaposed with the forward ends of the selected left and right sidewalls, so as to expose the selected chute adjacent the rearward end of the selected chute and thereby permit access to the selected chute adjacent the rearward end of the selected chute from a forward position adjacent a corresponding dispensing location of the matrix of dispensing locations to enable restocking of the selected chute directly adjacent the rearward end of the selected chute.

In addition, the present invention provides a method for accommodating the display, dispensing by gravity-feed, and restocking of merchandise articles selected from merchandise articles of different dimensions, including merchandise articles having different lateral widths and different altitudinal heights, at a matrix of dispensing locations placed at a point-of-purchase, the method comprising: selecting at least one left side wall from a plurality of left sidewalls, wherein each left sidewall has a forward end, a rearward end, a lower edge, an upper edge, and an inner face extending longitudinally between the forward and rearward ends and altitudinally between the lower and upper edges; selecting at least one right sidewall from a plurality of right sidewalls, wherein each right sidewall has a forward end, a rearward end, a lower edge, an upper edge, and an inner face extending longitudinally between the forward and rearward ends and altitudinally between the lower and upper edges; selecting at least one chute from a plurality of chutes, wherein each chute extends along a longitudinal direction between a forward end and a rearward end, each chute having a left side, a right side and a lateral width between the left side and the right side, the lateral width of at least some of the chutes of the plurality of chutes being different from others of the plurality of chutes, the different lateral widths of the chutes corresponding to the different lateral widths of the merchandise articles; engaging the selected chute within retainers provided on the inner face of each sidewall, wherein the retainers extend along respective longitudinal directions between respective forward and rearward ends of the left sidewall and the right sidewall, the retainers being dimensioned and configured for receiving the selected chute in engagement with tracks along the selected left and right sidewalls to establish a corresponding path of travel along the selected chute for merchandise articles along the corresponding longitudinal direction toward a corresponding dispensing location; the selected chute being received in sliding engagement with the selected left and right sidewalls such that upon engagement of the selected chute with retainers of the selected left and right sidewalls, the selected left sidewall and the selected right sidewall are spaced apart by the lateral width of the selected chute, and the selected chute is coupled with the selected left and right sidewalls for sliding movement; and selectively sliding the selected chute between a retracted position, wherein the rearward end of the selected chute is juxtaposed with the rearward ends of the selected left and right sidewalls, while the forward end of the selected chute is placed at a corresponding dispensing location juxtaposed with the forward ends of the selected left and right sidewalls, and an advanced position, wherein the rearward end of the selected chute is juxtaposed with the forward ends of the selected left and right sidewalls, with the selected chute exposed adjacent the rearward end of the selected chute so as to enable the selected chute to be reached adjacent the rearward end of the selected chute from adjacent a corresponding dispensing location of the matrix of dispensing locations for effecting re-stocking of the selected chute directly adjacent the rearward end of the selected chute.

The present invention will be understood more fully, while still further objects and advantages will become apparent, in the following detailed description of preferred embodiments of the invention illustrated in the accompanying drawing, in which:

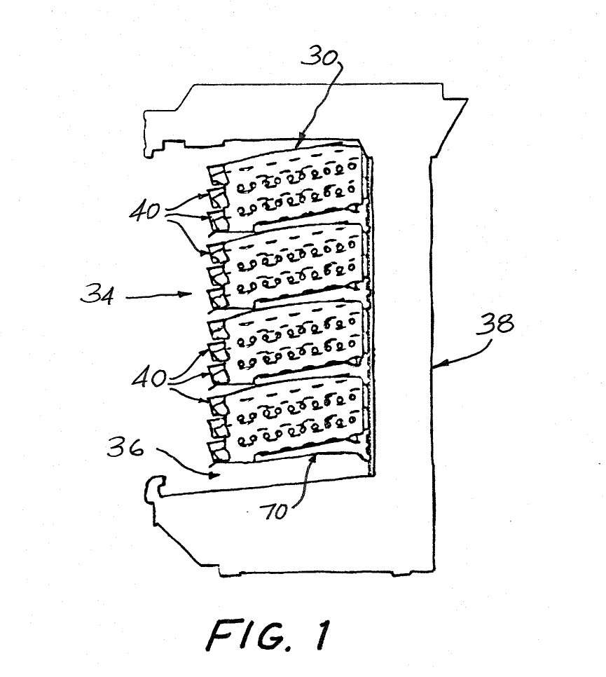

FIG. 1 is a somewhat diagrammatic representation of a refrigerated case placed at a point-of-purchase in a retail setting and utilizing apparatus constructed in accordance with the present invention;

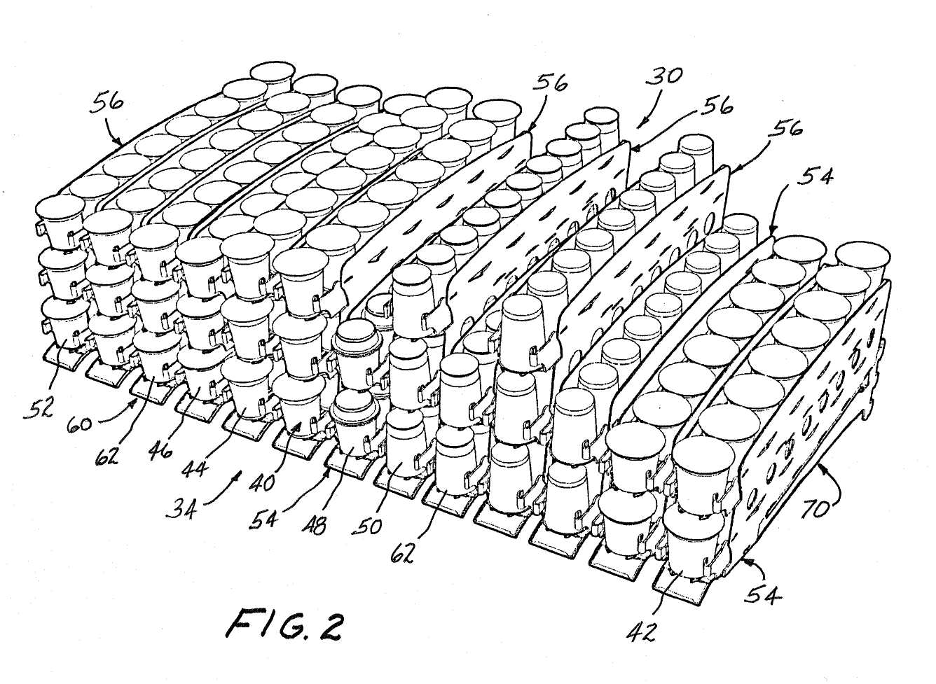

FIG. 2 is a pictorial view of a display and dispensing apparatus assembled from a system of modular components, in accordance with the present invention, and for placement at a point-of-purchase;

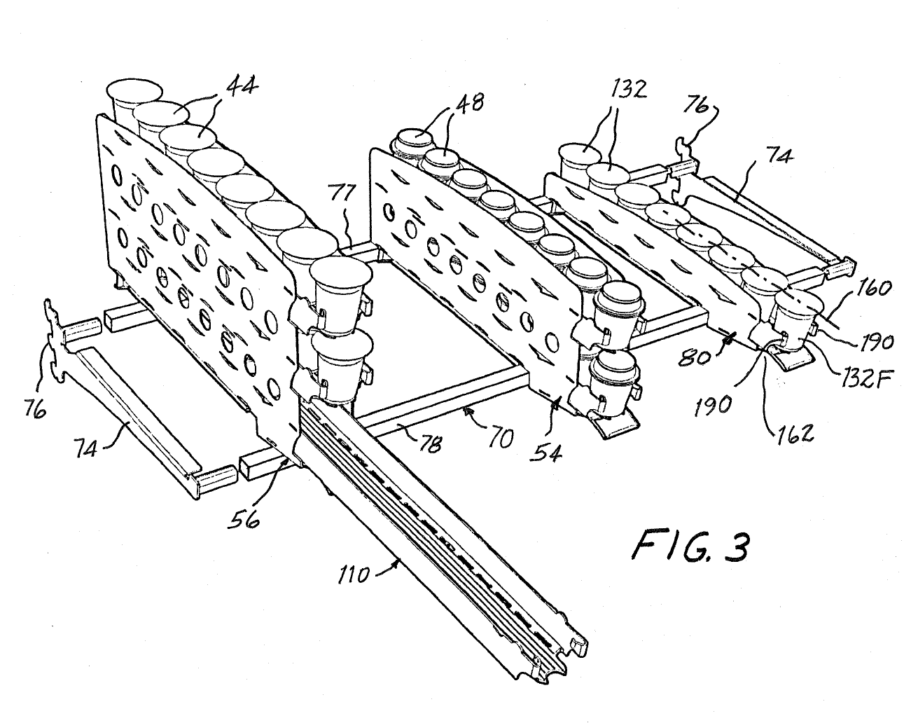

FIG. 3 is an exploded pictorial view, partially diagrammatic, showing components constructed in accordance with the invention, some of which are illustrated in FIG. 2;

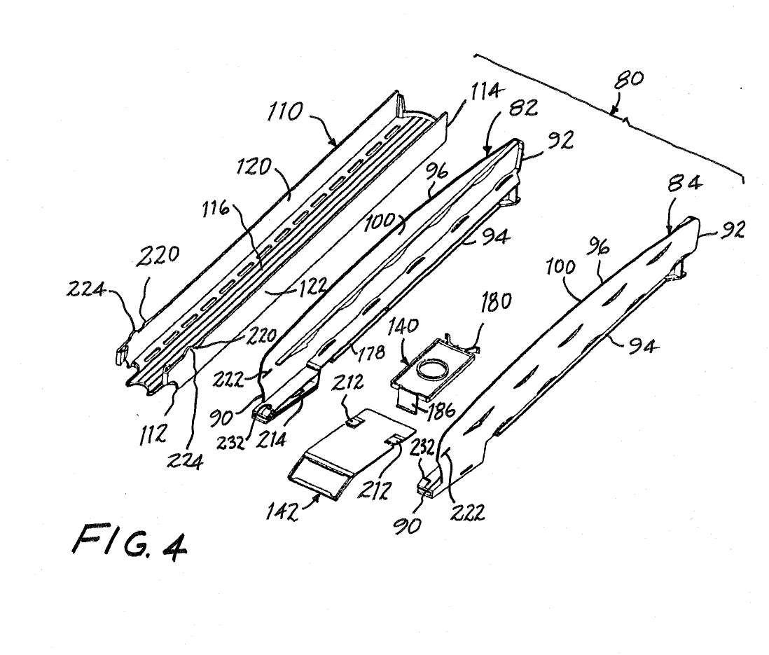

FIG. 4 is an exploded pictorial view of one display and dispensing arrangement illustrated in FIG. 3;

FIG. 5 is a side elevational view of a component of the arrangement illustrated in FIG. 4;

FIG. 6 is an enlarged cross-sectional view taken along line 6-6 of FIG. 5;

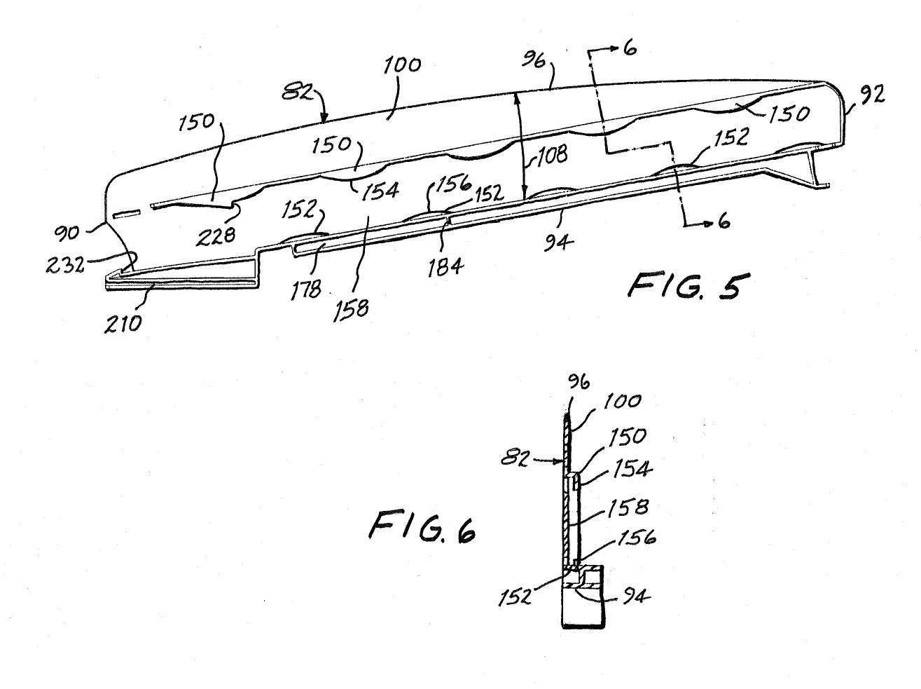

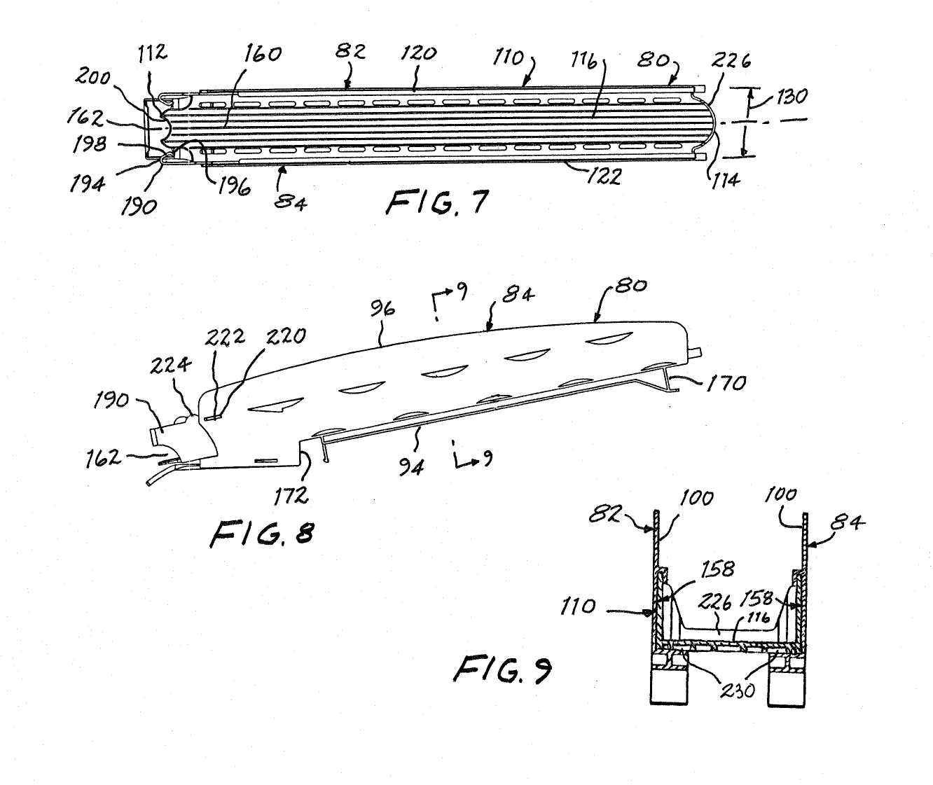

FIG. 7 is a top plan view of the one arrangement depicted in FIG. 4, and shown here with components assembled;

FIG. 8 is a side elevational view of the one arrangement;

FIG. 9 is an enlarged cross-sectional view taken along line 9-9 of FIG. 8;

FIG. 10 is a fragmentary top plan view showing the one arrangement installed in place, as seen in FIG. 3;

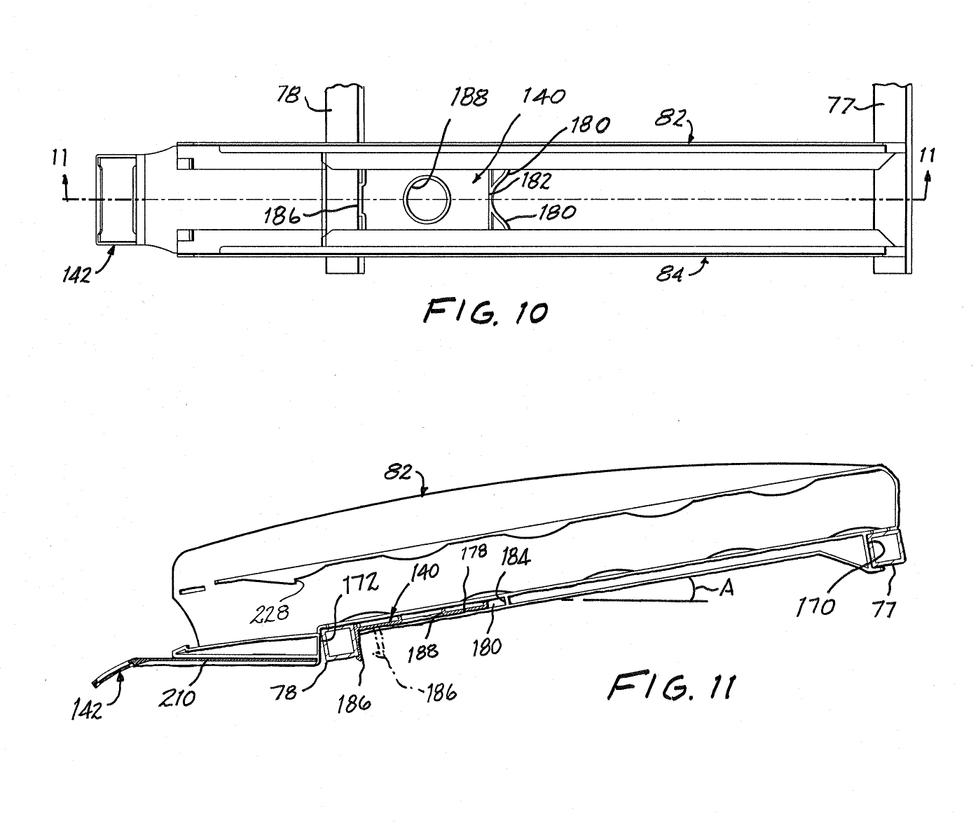

FIG. 11 is a longitudinal cross-sectional view taken along line 11-11 of FIG. 10;

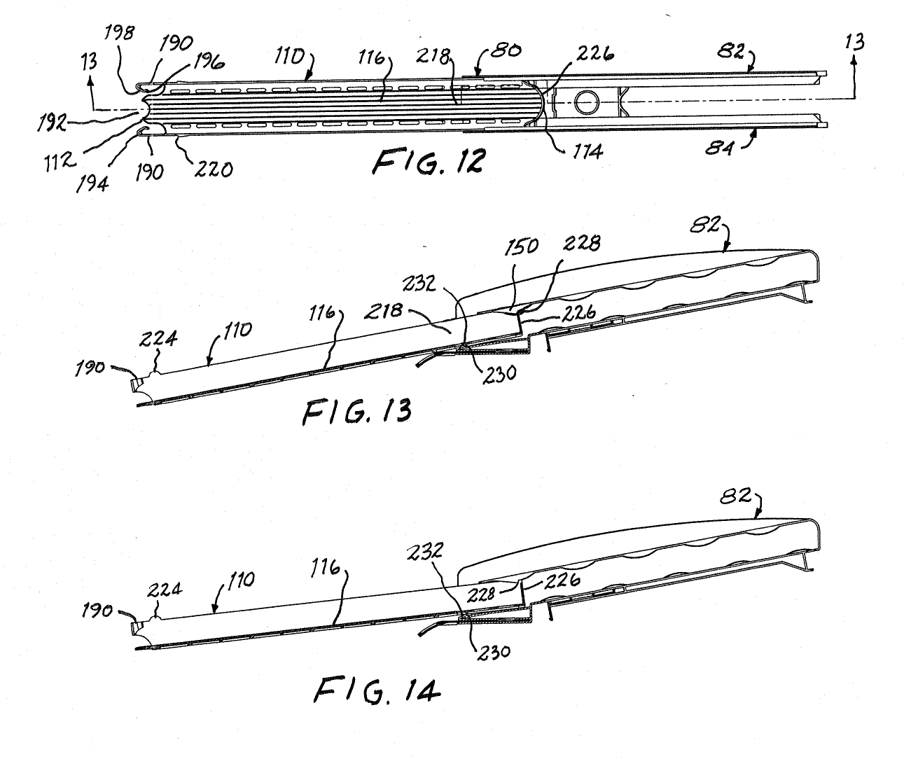

FIG. 12 is a top plan view of the one arrangement, showing the components in another position;

FIG. 13 is a longitudinal cross-sectional view taken along line 13-13 of FIG. 12;

FIG. 14 is a longitudinal cross-sectional view similar to FIG. 13 and showing the components in still another position;

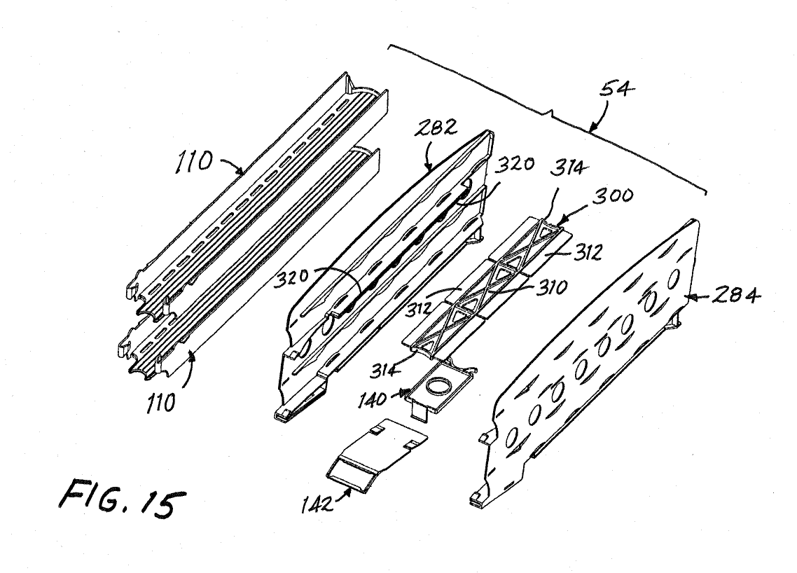

FIG. 15 is an exploded pictorial view of another display and dispensing arrangement illustrated in FIG. 3;

FIG. 16 is a side elevational view of a component of the arrangement illustrated in FIG. 15;

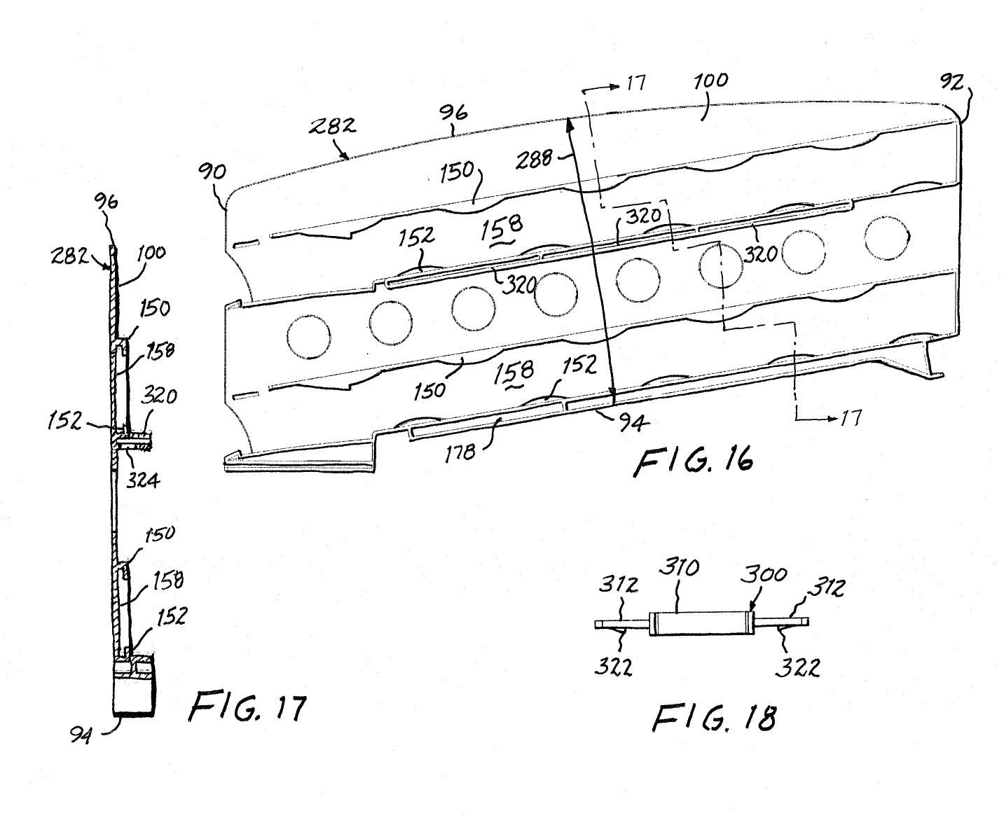

FIG. 17 is a cross-sectional view taken along line 17-17 of FIG. 16;

FIG. 18 is a front elevational view of another component of the arrangement illustrated in FIG. 15;

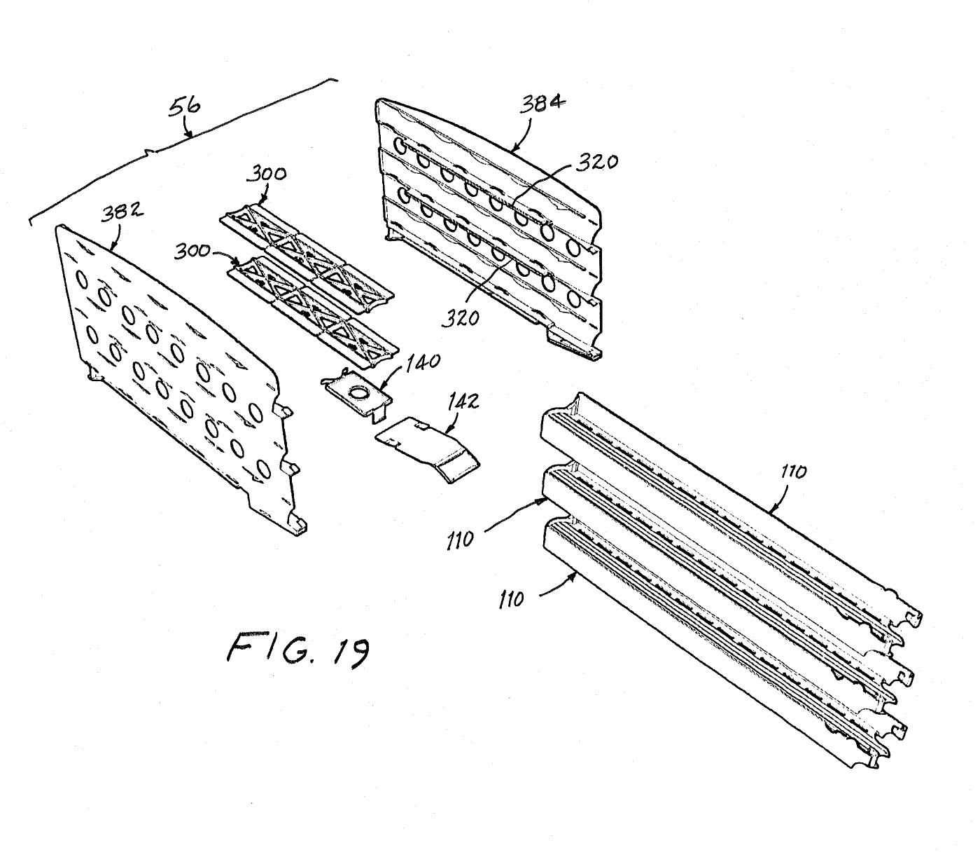

FIG. 19 is an exploded pictorial view of still another display and dispensing arrangement illustrated in FIG. 3;

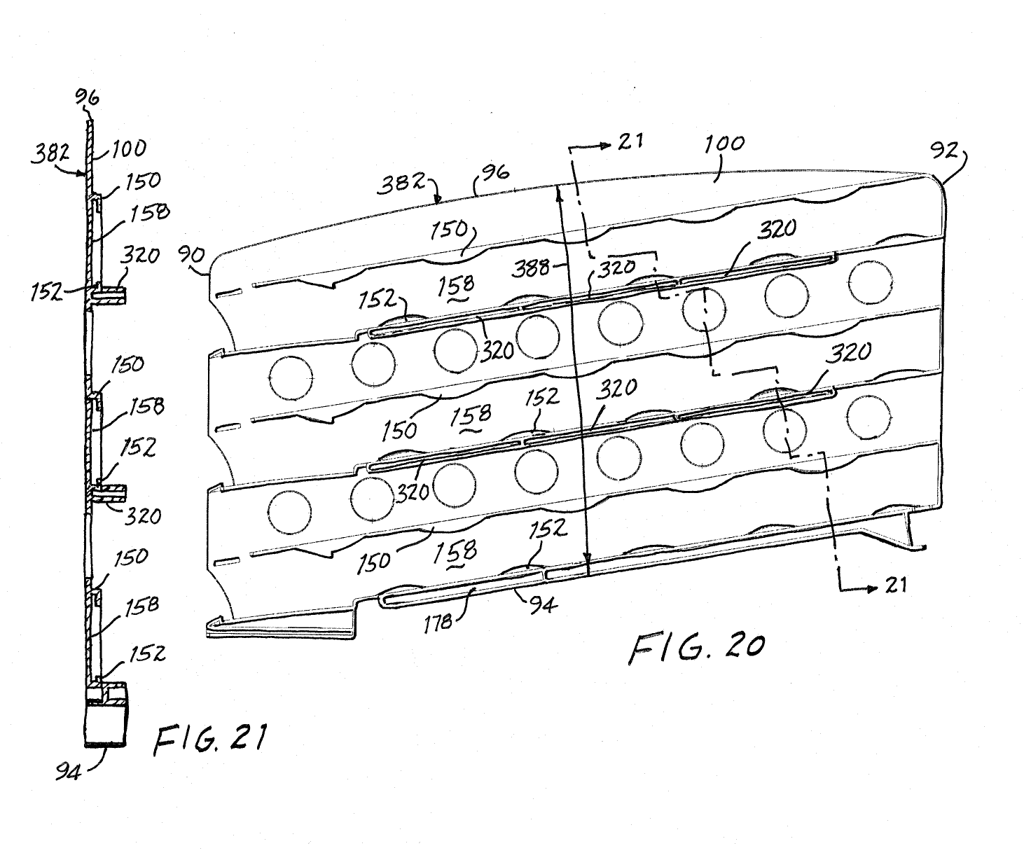

FIG. 20 is a side elevational view of a component of the arrangement illustrated in FIG. 19; and

FIG. 21 is a cross-sectional view taken along line 21-21 of FIG. 20.

Referring now to the drawing, and especially to FIGS. 1 and 2 thereof, a display and dispensing apparatus 30 is comprised of assembled components selected from modular components constructed in accordance with a system of the present invention and assembled in accordance with a method of the present invention to present merchandise articles for display and dispensing at a point-of-purchase 34. In the illustrated embodiment of FIGS. 1 and 2, the merchandise articles are in the form of containers of yogurt and apparatus 30 is to be placed within a refrigerated space, as exemplified by space 36 of refrigerated case 38, with yogurt containers 40 presented at the point-of-purchase 34 which is open to provide ready access by a consumer (not shown) for the selection of a container 40 in a retail setting. The yogurt containers 40 are of different dimensions, that is, some containers 40 have a lateral width different from other containers 40, while some containers 40 have an altitudinal height different from other containers 40. Thus, for example, containers 42 have a width greater than containers 44, containers 46 have a width similar to containers 44, but are shorter. Containers 48 have a different configuration, but include overall dimensions similar to containers 42. Containers 50 have still another configuration and are somewhat taller than containers 46, while containers 52 are shorter than containers 50. Some of the containers 40 are shown presented in two-tier sections 54, while others are presented in three-tier sections 56. In general, and as illustrated, yogurt containers are made available in a variety of sizes, and the components of apparatus 30 have been selected from a system of modular components, as will be described below, to accommodate a variety of sizes, and to present all of the containers 40 of different sizes for display and dispensing at a matrix 60 of dispensing locations 62, all placed at the point-of-purchase 34. Matrix 60 is relatively compact, that is, the sections 54 and 56, and the corresponding dispensing locations 62, are placed closely adjacent to one-another in order to conserve space within the controlled environment which provides the refrigerated space 36, while at the same time accommodating a maximum number of containers 40 in a minimum amount of space, so as to conserve energy through a more efficient display and dispensing arrangement.

Turning now to FIG. 3, individual sections of a typical display and dispensing apparatus constructed in accordance with the present invention are shown in a somewhat diagrammatic fashion to illustrate the manner in which various sections are affixed to a support structure, shown in the form of a rack 70, for placement in a refrigerated environment, such as that provided by space 36 of refrigerated case 38. Rack 70 includes brackets 74, each of which brackets 74 has a mounting configuration 76 enabling rack 70 to be installed in refrigerated case 38 in a now-conventional manner. To that end, rack 70 further includes a rearward support bar 77 and a forward support bar 78, both of which support bars 77 and 78 extend laterally between the brackets 74. FIG. 3 shows only a few sections for illustrative purposes. Thus, a single-tier section is shown at 80, while a two-tier section 54 and a three-tier section 56 are carried over from FIG. 2.

Looking first at single-tier section 80, and with reference to FIGS. 4 through 14, as well as to FIG. 3, the system of the present invention enables the assembly of the single-tier section 80 by selecting components from a plurality of components of different dimensions made available in the system. The components selected for assembling section 80 include a left sidewall 82 and a right sidewall 84 which is a mirror-image of left sidewall 82. Each sidewall 82 and 84 has a forward end 90, a rearward end 92, a lower edge 94 and an upper edge 96. Left sidewall 82 includes an inner face 100 which extends in a longitudinal direction between the forward and rearward ends 90 and 92 and in an altitudinal direction between the lower and upper edges 94 and 96 of left sidewall 82. Likewise, right sidewall 84 includes an inner face 100 extending in a longitudinal direction between the forward and rearward ends 90 and 92 and in an altitudinal direction between the lower and upper edges 94 and 96 of the right sidewall 84. Both sidewalls 82 and 84 have an altitudinal height 108 extending between respective lower and upper edges 94 and 96.

A chute 110 extends along a longitudinal direction between a forward end 112 and a rearward end 114 and includes a bottom 116, a left side 120 and a right side 122 spaced from the left side 120 by a prescribed lateral width 130 spanned by bottom 116. The lateral width 130 corresponds to the lateral width of selected containers 132 shown in FIG. 3, carried by chute 110 aligned along the longitudinal direction in which chute 110 extends. In addition to chute 110, section 80 includes a catch member 140 and a holder 142, both of these components being provided for purposes to be described below.

The inner face 100 of left sidewall 82 carries retainers, shown in the form of upper L-shaped members 150 spaced from one-another along the longitudinal direction to establish a series of spaced apart upper L-shaped members 150, and lower L-shaped members 152, also spaced from one-another along the longitudinal direction to establish a series of lower L-shaped members 152. Likewise, the inner face 100 of right sidewall 84 carries similar retainers, shown in the form of upper L-shaped members 150 spaced from one-another along the longitudinal direction to establish a series of spaced apart upper L-shaped members 150, and lower L-shaped members 152, also spaced from one-another along the longitudinal direction to establish a series of lower L-shaped members 152. In both the left and the right sidewalls 82 and 84 the upper L-shaped members 150 depend downwardly at 154, while lower L-shaped members 152 are staggered longitudinally with respect to upper L-shaped members 150 and project upwardly at 156 so that together, the two series of L-shaped members 150 and 152 establish a track 158 along each inner face 100, the tracks 158 being dimensioned and configured to receive corresponding sides 120 and 122 of chute 110, as best seen in FIG. 9. The configuration of the L-shaped members 150 and 152, together with the spaced apart and staggered arrangement of the L-shaped members 150 and 152, renders the sidewalls 82 and 84 structurally sound while being readily and economically manufactured by injection molding the sidewalls of a synthetic polymeric material.

With the chute 110 engaged within the tracks 158 established by the L-shaped members 150 and 152, a path of travel 160 is established for the containers 132 carried by the chute 110, with the path of travel 160 extending along the longitudinal direction toward a dispensing location 162. At the same time, the engagement of chute 110 with the L-shaped members 150 and 152 serves to integrate the left sidewall 82 and the right sidewall 84 with the chute 110 within the section 80, with the left and right sidewalls 82 and 84 spaced apart by a prescribed lateral width determined by the lateral width 130 of chute 110.

The left and right sidewalls 82 and 84 each include a support configuration, shown in the form of a rearward recess 170 and a forward recess 172, both of which are located along respective lower edges 94 of the left and right sidewalls 82 and 84. As best seen in FIGS. 10 and 11 (wherein chute 110 has been deleted for illustrative purposes), section 80 is mounted upon rack 70 by engaging rearward recesses 170 of the left and right sidewalls 82 and 84 with rearward support bar 77 of rack 70, and engaging forward recesses 172 with forward support bar 78. Before assembling chute 110 with left and right sidewalls 82 and 84, a catch member 140 is placed between the side walls 82 and 84 by inserting the catch member 140 into a complementary channel 178 located at the lower edge 94 of each sidewall 82 and 84, wherein the catch member 140 is received for sliding movement in forward and rearward directions. Leaf springs 180 extend from the rear 182 of catch member 140 and engage a web 184 placed within each channel 178 to bias catch member 140 in a forward direction. Catch member 140 carries a latch 186 which depends downwardly so as to engage forward support bar 78 of rack 70 when latch 186 is in a latched position, as seen in full lines in FIG. 11, and thereby secure sidewalls 82 and 84 and, consequently, section 80 in place on rack 70. When it is desired to release section 80 from rack 70, a finger hole 188 in catch member 140 allows an operator (not shown) to engage the catch member 140 and move the catch member 140 rearwardly, against the bias of leaf springs 180, to move latch 186 to an unlatched position, out of engagement with forward support bar 78 of rack 70, as seen in phantom in FIG. 11, thereby releasing section 80 for movement upwardly and forward to disengage section 80 from rack 70.

With the chute 110 assembled with left and right sidewalls 82 and 84, and section 80 mounted upon rack 70, chute 110 is oriented at an angle A relative to a horizontal direction, angle A being sufficient to bias containers 132 by gravity-feed along the longitudinal direction and path of travel 160 toward dispensing location 162, where the forwardmost container 132F is retained in place at dispensing location 162 by resilient arms 190, preferably formed unitary with the forward end 112 of chute 110 to establish a gate 192. A consumer (not shown) selectively may withdraw the forwardmost container 132F merely by grasping the container 132F and pulling the container 132F forward, through the gate 192. Arms 190 include tapered ends 194 which provide a rear face 196 angled to facilitate withdrawal of a container 132 through gate 192 and a front face 198 angled to permit the consumer to return a withdrawn container 132 merely by pushing the container 132 back through the gate 192, all as facilitated by a finger notch 200 in bottom 116, at the forward end 112 of chute 110. For the convenience of the consumer, a holder 142 is inserted into complementary grooves 210 in sidewalls 82 and 84 to be held in place at the forward end 90 of each sidewall 82 and 84, by a retention arrangement, shown in the form of tabs 212, formed as a part of holder 142, for engagement with a corresponding aperture 214 in each sidewall 82 and 84, so as to present identifying information at the dispensing location 162, in a now well-known manner.

The preferred method for restocking chute 110 is to insert fresh containers 132 adjacent the rearward end 114 of the chute 110, allowing existing containers 132 to move forward for dispensing before a restocked container 132 arrives at the dispensing location 162. Generally, the most convenient access to chute 110 is gained from a forward position adjacent the dispensing location 162 at the forward end 112 of the chute 110. However, with a densely populated apparatus, as illustrated in FIGS. 1 and 2, access to the chute 110 adjacent the rearward end 114 usually is not available from a forward position without displacing or removing all or at least some of the containers 132 located ahead of the rearward end 114 of the chute 110. In order to provide convenient access to a location adjacent the rearward end 114 of chute 110 for restocking chute 110 from a forward position adjacent the dispensing location 162 at the forward end 112 of the chute 110, chute 110 is engaged within tracks 158 for sliding movement between a retracted position, wherein the rearward end 114 of chute 110 is juxtaposed with the rearward ends 92 of the left and right sidewalls 82 and 84, while the forward end 112 of the chute 110 is placed at the dispensing location 162, juxtaposed with the forward ends 90 of the left and right sidewalls 82 and 84, as illustrated in FIGS. 7 and 8, and an advanced position, wherein the rearward end 114 of the chute 110 is juxtaposed with the forward ends 90 of the left and right sidewalls 82 and 84, thus exposing the chute 110 adjacent the rearward end 114 of the chute 110, as illustrated at 218 in FIGS. 12 and 13, as well as in FIG. 3, thereby enabling chute 110 to be accessed adjacent the rearward end 114 of the chute 110 from a forward position adjacent the dispensing location 162 for restocking chute 110 directly, adjacent the rearward end 114 of chute 110.

With further reference to FIGS. 7 and 8, and FIGS. 12 and 13, as well as FIG. 4, a detent arrangement retains the chute 110 at the retracted position and is disengaged selectively to enable movement of chute 110 to the advanced position. The detent arrangement includes detent elements in the form of detent projections 220 projecting from the sides 120 and 122 of the chute 110, adjacent the forward end 112 of the chute 110, and complementary detent slots 222 in the left and right sidewalls 82 and 84, located for engagement by counterpart detent projections 220 when the chute 110 is in the retracted position. Each detent projection 220 is seen to be provided with a ramped configuration to ease the detent projections 220 into engagement with the detent slots 222 upon movement of chute 110 into the retracted position.

When it is desired to disengage the detent projections 220 from the detent slots 222, finger tabs 224 on the sides 120 and 122 of the chute 110, adjacent the detent projections 220, are squeezed laterally toward one-another to displace the sides 120 and 122 slightly toward one-another in the vicinity of the projections 220, such displacement being enough to disengage the projections 220 from the slots 222 and thereby release the chute 110 for movement away from the retracted position toward the advanced position. Once the chute 110 reaches the advanced position, as depicted in FIGS. 12 and 13, rear wall 226 of the chute 110 will engage stops 228 provided on the forwardmost L-shaped member 150 of the left and right sidewalls 82 and 84, and a rib 230 carried by the chute 110 and depending from bottom 116 of chute 110 will engage further stops 232 on the left and right sidewalls 82 and 84, effectively precluding further forward movement of the chute 110, thereby preventing inadvertent removal of chute 110 from between sidewalls 82 and 84. When it is desired to remove chute 110 completely from between the left and right sidewalls 82 and 84, chute 110 merely is tilted slightly, while in the advanced position, as illustrated in FIG. 14, to drop rear wall 226 below stops 228 and simultaneously lift rib 230 over stops 232, thereby permitting forward movement of the chute 110 beyond the advanced position and out from between left and right sidewalls 82 and 84.

Turning now to FIGS. 15 through 18, as well as to FIG. 3, the system of the present invention enables the assembly of two-tier section 54 by selecting components from a plurality of components of different dimensions made available in the system. The components selected for assembly of two-tier section 54 are constructed similar to the components selected for assembling the single-tier section 80, and similar reference characters have been employed to identify similar component parts and similar structural features. However, in order to accommodate two tiers of merchandise articles, here shown in the form of containers 48, two-tier section 54 includes left and right sidewalls 282 and 284, respectively, which differ from left and right sidewalls 82 and 84 of single-tier section 80 in that the altitudinal height 288 between lower and upper edges 94 and 96 of left and right sidewalls 282 and 284 is greater than the altitudinal height 108 of left and right sidewalls 82 and 84 so as to provide enough space on each sidewall 282 and 284 for two tracks 158 spaced apart in altitudinal directions, each track 158 being established by two corresponding series of L-shaped members 150 and 152. In this manner, section 54 accommodates two chutes 110 spaced apart altitudinally from one-another and maximize the number of containers 40 which can be accommodated in a minimum space. In a manner similar to that described above in connection with section 80, chutes 110 each are engaged with sidewalls 282 and 284 for sliding movement between a retracted position for displaying and dispensing, and an advanced position for restocking, thereby providing all of the advantages described above, including the ability to reach each chute 110 adjacent the rear wall 226 of the chute 110 from a forward position adjacent a corresponding dispensing location 162 for restocking each chute 110 directly adjacent the rearward end 114 of the chute 110, conveniently from the forward position adjacent the corresponding dispensing location 162. As in single-tier section 80, two-tier section 54 receives a catch member 140 for securing section 54 mounted upon rack 70. A holder 142 is placed at the forward ends 90 of the sidewalls 282 and 284 for presenting identifying information pertaining to the containers 48 carried by chutes 110.

In order to provide a measure of structural integrity and rigidity, and especially to assure that the desired lateral spacing between sidewalls 282 and 284 is maintained substantially fixed so as to facilitate the sliding engagement of chutes 110 within tracks 158, the components of the system of the invention include a spacer 300 having a longitudinal length for extending along a substantial portion of the longitudinal length of the sidewalls 282 and 284 between forward and rearward ends 90 and 92. Spacer 300 includes an essentially rigid brace section 310 having a lateral width corresponding to the lateral width of a chute 110 selected for interposition between the sidewalls 282 and 284, and flanges 312 projecting laterally from the brace section 310 and placed along the longitudinal direction, between longitudinally opposite ends 314 of the spacer 300. As best seen in FIGS. 16 through 18, sidewalls 282 and 284 (right sidewall 284 being a mirror-image of left sidewall 282) carry elongate sockets 320 along corresponding inner face 100, sockets 320 being generally complementary to flanges 312 so that the flanges 312 and sockets 320 provide a coupling arrangement wherein each flange 312 is received within a counterpart socket 320 to couple spacer 300 with sidewalls 282 and 284, with brace section 310 placed between the sidewalls 282 and 284. Each flange 312 includes a barb 322 (see FIG. 18) such that upon seating a flange 312 within a corresponding socket 320, a corresponding barb 322 will enter a counterpart recess 324 (see FIG. 17) in the socket 320 to secure the flange 312 and, consequently, the spacer 300 firmly in place between the sidewalls 282 and 284, thus reinforcing the desired lateral spacing between the sidewalls 282 and 284, while providing added structural rigidity to section 54.

Referring now to FIGS. 19 through 21, as well as to FIG. 3, the system of the present invention enables the assembly of three-tier section 56 by selecting components from a plurality of components of different dimensions made available in the system. The components selected for assembly of three-tier section 56 are similar to the components selected for assembling the single-tier section 80 and the two-tier section 54, and similar reference characters have been employed to identify similar component parts and similar structural features. However, in order to accommodate three tiers of merchandise articles, here shown as containers 44, three-tier section 56 includes left and right sidewalls 382 and 384, respectively, which differ from left and right sidewalls 82 and 84 of single-tier section 80 and from left and right sidewalls 282 and 284 of two-tier section 54 in that the altitudinal height 388 between lower and upper edges 94 and 96 of left and right sidewalls 382 and 384 is greater than the altitudinal height 108 of left and right sidewalls 82 and 84, and greater than the altitudinal height 288 of left and right sidewalls 282 and 284, so as to provide each sidewall 382 and 384 with three tracks 158 spaced apart in altitudinal directions, each track 158 being established by two corresponding series of L-shaped members 150 and 152. In this manner, section 56 accommodates three chutes 110 spaced apart altitudinally from one-another to maximize the number of containers 44 accommodated in a minimum space. As described above, in connection with sections 80 and 54, chutes 110 are engaged with sidewalls 382 and 384 for sliding movement between a retracted position for displaying and dispensing, and an advanced position for restocking, thereby providing all of the advantages described above, including the ability to reach each chute 110 adjacent the rear wall 226 of the chute 110 from a forward position adjacent a corresponding dispensing location 162 for restocking each chute 110 directly adjacent the rearward end 114 of the chute 110, conveniently from the forward position adjacent the corresponding dispensing location 162. As in single-tier section 80, three-tier section 56 receives a catch member 140 for securing section 56 mounted upon rack 70, and a holder 142 is placed at the forward ends 90 of the sidewalls 382 and 384 for presenting identifying information pertaining to the containers 44 carried by chutes 110.

In order to provide a measure of structural integrity and rigidity, and especially to assure that the desired lateral spacing between sidewalls 382 and 384 is maintained substantially fixed so as to facilitate the sliding engagement of chutes 110 within tracks 158, the components of the system of the invention include a plurality of spacers 300, each having a longitudinal length for extending along a substantial portion of the longitudinal length of the sidewalls 382 and 384 between forward and rearward ends 90 and 92. As described above, spacers 300 each include an essentially rigid brace section 310 having a lateral width corresponding to the lateral width of the selected chutes 110, and flanges 312 projecting laterally from the brace section 310 and placed along the longitudinal direction, between longitudinally opposite ends 314 of the spacer 300. As best seen in FIGS. 20 and 21, as well as in FIG. 19, sidewalls 382 and 384 (right sidewall 384 being a mirror-image of left sidewall 382) carry elongate sockets 320 along inner faces 100, sockets 320 being generally complementary to flanges 312 so that each flange 312 is received within a corresponding socket 320 to place a brace section 310 between the sidewalls 382 and 384, and each spacer 300 is secured in place as described above in connection with the assembly of section 54. With each spacer 300 secured firmly in place between the sidewalls 382 and 384, the desired lateral spacing between the sidewalls 382 and 384 is reinforced, and additional structural rigidity is provided to section 56. In this instance, two spacers 300 are employed to brace the extended altitudinal height 388 of sidewalls 382 and 384 and lend added structural rigidity to section 56.

The system of the present invention provides a plurality of modular components of different dimensions, as exemplified by the plurality of sidewalls of different altitudinal heights, the plurality of chutes of different lateral widths, and the plurality of spacers, catch members and holders, all of different lateral widths, illustrated and described herein, for selection and assembly, as described above, to accommodate merchandise articles of different dimensions while establishing a relatively compact matrix of dispensing locations. For example, most currently available containers for yogurt are provided within a range of different lateral widths, including a narrow width, a medium width and a wide width, and three different altitudinal heights including a short height, a medium height and a tall height, all of which can be accommodated by making available three different sizes of chutes, six different sizes of left sidewalls, six different sizes of right sidewalls, three different sizes of spacers, three different sizes of catch members, and three different sizes of holders.

Thus, in one exemplary combination of modular components provided by the system of the present invention, a plurality of chutes 110 are made available in three different lateral widths, namely, a narrow width (about 3.0 inches), a medium width (about 3.2 inches), and a wide width (about 3.5 inches). Spacers, catch members and holders are made available in three comparable widths. The sidewalls 82 and 84 for assembling a single-tier section 80 are made available with a single altitudinal height, comprising a single size for accommodating a single tier of merchandise articles of all available heights. The sidewalls 282 and 284 for assembling a two-tier section 54 are made available in two different altitudinal heights, comprising two sizes, namely, one size for accommodating two tiers of merchandise articles of short and medium heights, and one size for accommodating two tiers of merchandise articles having a tall height. The sidewalls 382 and 384 for assembling a three-tier section 56 are made available in three different altitudinal heights, comprising three sizes, namely, a first size for accommodating three tiers of tall merchandise articles, a second size for accommodating three tiers of medium height merchandise articles, and a third size for accommodating three tiers of short merchandise articles. Thus, by combining any one of six matching pairs of sidewalls with an appropriate number of any selected one sized chute, together with a corresponding spacer or spacers for the multiple tier sections, and a catch member and a holder, each of a corresponding size, eighteen different configurations are made available for selection and assembly to establish a compact matrix of dispensing locations for maximizing the number of merchandise articles of different sizes which are accommodated, in accordance with the present invention, while enabling convenient restocking of every chute from a forward position, as described.

It will be seen that the present invention attains all of the objects and advantages summarized above, namely: Provides a system of modular components made available for enabling the assembly of selected components to accommodate the display and dispensing, by convenient gravity-feed, of merchandise articles of different dimensions at a relatively compact matrix of dispensing locations placed at a point-of-purchase; facilitates restocking of a gravity-feed merchandise article display and dispensing apparatus, conveniently from a forward position adjacent the dispensing location of the display and dispensing apparatus; enables a conservation of space at a point-of-purchase while providing for the display and dispensing at the point-of-purchase, by gravity-feed, of conveniently restocked merchandise articles selected from a plurality of merchandise articles of different dimensions, with a concomitant conservation of energy where the merchandise articles require a controlled environment, such as a refrigerated space; provides a very high degree of versatility in the ability to accommodate a maximum number of merchandise articles of different dimensions in a conveniently restocked gravity-feed display and dispensing apparatus of minimum dimensions; facilitates the establishment and maintenance of an attractive, well-stocked display and dispensing apparatus at a point-of-purchase for merchandise articles of various dimensions, particularly where the merchandise articles must be maintained in a controlled environment; provides a system of modular components of relatively simple construction and economical manufacture for selection to assemble a conveniently restocked gravity-feed display and dispensing apparatus that presents a maximum number of merchandise articles of different dimensions within a relatively compact matrix of dispensing locations placed at a point-of-purchase; enables simple, on-site assembly of an effective and conveniently restocked gravity-feed display and dispensing apparatus for accommodating merchandise articles of different dimensions with increased ease and economy, without the need for special tools or special skills, especially in locations requiring a controlled environment for the display and dispensing of the merchandise articles; provides for the reliable and economical display and dispensing of conveniently restocked merchandise articles of selected dimensions, over an extended service life.

It is to be understood that the above detailed description of preferred embodiments of the invention is provided by way of example only. Various details of design, construction and procedure may be modified without departing from the true spirit and scope of the invention, as set forth in the appended claims.

The embodiments of the invention in which an exclusive property or privilege is claimed are defined as follows:

1. A system of modular components for assembly of selected components of the system to accommodate a compact display, effective dispensing by gravity-feed, and convenient restocking of merchandise articles selected from merchandise articles of different dimensions, including merchandise articles having different lateral widths and different altitudinal heights, at a matrix of dispensing locations placed at a point-of-purchase, the system of modular components comprising:
a plurality of left and right sidewalls, each sidewall having a forward end, a rearward end, a lower edge, an upper edge, and an inner face extending longitudinally between the forward and rearward ends and altitudinally between the lower and upper edges;
a plurality of chutes, each chute extending along a longitudinal direction between a forward end and a rearward end, each chute having a left side, a right side and a lateral width between the left side and the right side, the lateral width of at least some of the chutes of the plurality of chutes being different from others of the plurality of chutes, the different lateral widths of the chutes corresponding to the different lateral widths of the merchandise articles; and
retainers on the inner face of each sidewall, the retainers extending along respective longitudinal directions between respective forward and rearward ends of the left sidewall and the right sidewall, the retainers being dimensioned and configured to establish a track along each sidewall for receiving a selected chute in engagement with the selected left and right sidewalls, with the tracks providing a corresponding path of travel for merchandise articles carried by the selected chute along the corresponding longitudinal direction toward a corresponding dispensing location;
the selected chute being received within the tracks in sliding engagement with the selected left and right sidewalls such that upon engagement of the selected chute with retainers of the selected left and right sidewalls, the selected left sidewall and the selected right sidewall will be spaced apart by the lateral width of the selected chute, and the selected chute will be coupled with the selected left and right sidewalls for sliding movement between a retracted position, wherein the rearward end of the selected chute is juxtaposed with the rearward ends of the selected left and right sidewalls, while the forward end of the selected chute is placed at a corresponding dispensing location juxtaposed with the forward ends of the selected left and right sidewalls so as to enable the display and dispensing of merchandise articles from the forward end of the selected chute, at the corresponding dispensing location, and an advanced position, wherein the rearward end of the selected chute is juxtaposed with the forward ends of the selected left and right sidewalls, so as to expose the selected chute adjacent the rearward end of the selected chute and thereby permit access to the selected chute adjacent the rearward end of the selected chute from a forward position adjacent a corresponding dispensing location of the matrix of dispensing locations to enable restocking of the selected chute directly adjacent the rearward end of the selected chute.

2. The system of claim 1 wherein at least some of the retainers are spaced apart in an altitudinal direction to establish tiered multiple tracks for multiple selected chutes of the same width spaced apart altitudinally relative to one-another to accommodate merchandise articles of different altitudinal heights along tiered corresponding paths of travel.

3. The system of claim 2 including:
a plurality of spacers, the spacers having different lateral widths corresponding to the different lateral widths of the chutes; and
a coupling arrangement for coupling at least one selected spacer with the selected left and right sidewalls so that the selected spacer stabilizes the selected left and right sidewalls spaced apart from one another by the lateral width of a selected chute.

4. The system of claim 3 wherein the left and right sidewalls each include a support configuration located along the respective lower edges of the left and right sidewalls, the support configuration being complementary to a support structure for mounting the left and right sidewalls upon the support structure.

5. The system of claim 4 including:
a plurality of catch members, the catch members having different lateral widths corresponding to the different lateral widths of the chutes; and
a placement arrangement for placing a selected catch member between selected left and right sidewalls adjacent the lower edges of the left and right sidewalls, the lateral width of the selected catch member corresponding to the lateral width of the selected chute;
the catch members each including a latch for engaging the support structure upon mounting the left and right sidewalls upon the support structure to secure the left and right sidewalls in place upon the support structure.

6. The system of claim 5 wherein the latch is selectively movable between a latched position, wherein the latch secures the left and right sidewalls upon the support structure, and an unlatched position, wherein the left and right sidewalls are released for removal from the support structure.

7. The system of claim 6 including a detent arrangement having selectively engaged detent elements for selective retention of the selected chute at the retracted position and for selective release of the selected chute for movement of the selected chute to the advanced position.

8. The system of claim 7 including stops on the left and right sidewalls for engagement with counterpart stops on a selected chute upon placement of the selected chute in the advanced position to preclude inadvertent movement of the selected chute forward beyond the advanced position.

9. The system of claim 8 including:
a plurality of holders for displaying information pertaining to the merchandise articles to be dispensed, the holders having different lateral widths corresponding to the different lateral widths of the chutes; and
a retention arrangement for retaining at least one selected holder on the selected left and right sidewalls in place at a corresponding dispensing location for view at the point-of-purchase.

10. The system of claim 1 including a detent arrangement having selectively engaged detent elements for selective retention of the selected chute at the retracted position and for selective release of the selected chute for movement of the selected chute to the advanced position.

11. The system of claim 1 including stops on the left and right sidewalls for engagement with counterpart stops on a selected chute upon placement of the selected chute in the advanced position to preclude inadvertent movement of the selected chute forward beyond the advanced position.

12. The system of claim 1 including:
a plurality of holders for displaying information pertaining to the merchandise articles to be dispensed, the holders having different lateral widths corresponding to the different lateral widths of the chutes; and
a retention arrangement for retaining at least one selected holder on the selected left and right sidewalls in place at a corresponding dispensing location for view at the point-of-purchase.

13. A method for accommodating the display, dispensing by gravity-feed, and restocking of merchandise articles selected from merchandise articles of different dimensions, including merchandise articles having different lateral widths and different altitudinal heights, at a matrix of dispensing locations placed at a point-of-purchase, the method comprising:
selecting at least one left side wall from a plurality of left sidewalls, wherein each left sidewall has a forward end, a rearward end, a lower edge, an upper edge, and an inner face extending longitudinally between the forward and rearward ends and altitudinally between the lower and upper edges;
selecting at least one right sidewall from a plurality of right sidewalls, wherein each right sidewall has a forward end, a rearward end, a lower edge, an upper edge, and an inner face extending longitudinally between the forward and rearward ends and altitudinally between the lower and upper edges;
selecting at least one chute from a plurality of chutes, wherein each chute extends along a longitudinal direction between a forward end and a rearward end, each chute having a left side, a right side and a lateral width between the left side and the right side, the lateral width of at least some of the chutes of the plurality of chutes being different from others of the plurality of chutes, the different lateral widths of the chutes corresponding to the different lateral widths of the merchandise articles;
engaging the selected chute within retainers provided on the inner face of each sidewall, wherein the retainers extend along respective longitudinal directions between respective forward and rearward ends of the left sidewall and the right sidewall, the retainers being dimensioned and configured for receiving the selected chute in engagement with tracks along the selected left and right sidewalls to establish a corresponding path of travel along the selected chute for merchandise articles along the corresponding longitudinal direction toward a corresponding dispensing location;
the selected chute being received in sliding engagement with the selected left and right sidewalls such that upon engagement of the selected chute with retainers of the selected left and right sidewalls, the selected left sidewall and the selected right sidewall are spaced apart by the lateral width of the selected chute, and the selected chute is coupled with the selected left and right sidewalls for sliding movement; and
selectively sliding the selected chute between a retracted position, wherein the rearward end of the selected chute is juxtaposed with the rearward ends of the selected left and right sidewalls, while the forward end of the selected chute is placed at a corresponding dispensing location juxtaposed with the forward ends of the selected left and right sidewalls, and an advanced position, wherein the rearward end of the selected chute is juxtaposed with the forward ends of the selected left and right sidewalls, with the selected chute exposed adjacent the rearward end of the selected chute so as to enable the selected chute to be reached adjacent the rearward end of the selected chute from adjacent a corresponding dispensing location of the matrix of dispensing locations for effecting re-stocking of the selected chute directly adjacent the rearward end of the selected chute.

14. The method of claim 13 wherein at least some of the retainers are spaced apart in an altitudinal direction to establish tiered multiple tracks and corresponding tiered multiple paths of travel, and the method includes selecting multiple chutes of the same width and engaging the selected multiple chutes within the retainers, along corresponding longitudinal directions to establish tiered corresponding paths of travel.
